(19) United States
(12) Patent Application Publication
(10) Pub. No.: US 2011/0168656 A1
(43) Pub. Date: Jul. 14, 2011

(54) Feeding Bottle

(75) Inventor: Eckhard Itzek, Ghyum-Nartum (DE)

(73) Assignee: MAPA GMBH GUMMI- UND PLASTIKWERKE, Zeven (DE)

(21) Appl. No.: 12/866,651

(22) PCT Filed: Feb. 6, 2009
(86) PCT No.: PCT/EP2009/000846

§ 371 Date: Oct. 14, 2010

(30) Foreign Application Priority Data
Feb. 8, 2008 (DE) 10 2008 008 116.7

(51) Int. Cl. A61J 9/00

(52) U.S. Cl. 215/11.1

(57) ABSTRACT

The invention relates to a feeding bottle having a drinking teat made of a flexible plastic, a bottle made from plastic having higher strength than the flexible plastic and connected to the drinking teat in one piece by means of injection molding, and a reinforcement thread extending from the bottle through the drinking teat up to the drinking opening.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The invention relates to a feeding bottle, in particular for babies and small children.

Feeding bottles are used for dispensing milk and other liquid food, in particular to children. Known feeding bottles have a bottle and a drinking teat which may be fixed by means of a threaded ring to an external thread of the bottle, which surrounds the opening of the bottle. Such a feeding bottle is disclosed in DE 197 39 911 A1.

Bottles are already known, moreover, in which the bottle and the drinking teat are produced in one piece from the same material. According to DE 1 541 354 B and DE 1 918 688 A such feeding bottles are produced from thermoplastic material in a blow process on bottle blowing machines. In the feeding bottle according to DE 1 541 354 B, the suction opening is closed by an inserted needle-shaped stopper. The feeding bottle according to DE 1 918 688 A1 has at the outlet end of the comforter a moulded-on hollow tip which is cut off when removing the contents of the bottle.

According to DE 1 906 760 A, a blank which is extruded or injection-moulded or produced by thermoforming from a plastics film is stretched in a mould to form the teat and/or the tip of the teat, so that the wall thickness of the teat is less than that of the wall of the body of the feeding bottle. In this feeding bottle, a drinking opening subsequently has to be bored or cut into the teat.

From DE 1 791 261 A a disposable bottle made of plastic is known in which a teat-shaped end is rigidly connected to a bottle body by welding or bonding after the production thereof. As a result, a material connection is produced. Moreover, this document discloses a feeding bottle in which the neck of the teat-shaped end is connected by shrinking onto the bottle body. The bottle body and the teat-shaped end may be designed from different plastics, which is advantageous with regard to the strength of the bottle body relative to the resilience of the teat-shaped end. Said feeding bottle has a mushroom-shaped element which is inserted into the opening of the teat, in order to close said opening. The mushroom-shaped element has a thickened lower end so that it holds itself in the opening. Additionally, it is secured by means of a shrink film, which encloses the feeding bottle.

The known one-piece feeding bottles comprising a drinking teat and a bottle made of the same material have an insufficiently rigid bottle and/or an insufficiently flexible drinking teat. In the known one-piece drinking bottles with a welded or bonded connection between the resilient drinking teat and bottle made of a plastic of higher strength, the connecting region and the drinking teat are at risk of being destroyed.

WO 01/03643 A1 discloses a feeding bottle for babies with a drinking teat made of a flexible plastic with a planar edge which is heat-welded to a bottle. The drinking teat has a closure pin which protrudes from a drinking opening and which has a mushroom-head-shaped widening on the upper face. The closure element is preferably formed in one piece with the drinking teat and may be fastened to the inside of a cover, so that the drinking teat is automatically opened by removing the cover. The drinking teat may be provided with a small recess, in which the closure pin engages. The closure pin is broken off at this point when the drinking bottle is opened for removing liquid.

A drawback with the known feeding bottle is that the drinking teat may be easily detached from the bottle. Moreover, the diameter of the drinking opening, which is produced by breaking off the closure pin, may vary considerably. In particular, a very large drinking opening may be produced if the closure pin is pulled out abruptly. As a result, the quantity of liquid which the opened drinking teat dispenses at a specific negative suction pressure is very different from one feeding bottle to another.

### BRIEF SUMMARY OF THE INVENTION

Proceeding therefrom, the object of the invention is to provide a one-piece feeding bottle with a flexible drinking teat and bottle of improved strength.

The feeding bottle according to the invention has a drinking teat made of a flexible plastic, a bottle made from plastic having a higher strength than the flexible plastic and connected to the drinking teat in one piece by means of injection-moulding and a reinforcement thread extending from the bottle through the drinking teat up to the drinking opening.

In the feeding bottle according to the invention, the bottle and drinking teat are connected to one another in one piece by injection-moulding. The bottle and drinking teat may thus be produced in a multi-component injection-moulding process. The connection between the bottle and drinking teat may be positive and/or non-positive and/or a material connection. A positive connection may be achieved by a positive engagement of the drinking teat and bottle. A non-positive connection between the drinking teat and bottle is, for example, achieved by the drinking teat and bottle being produced from different plastics, which shrink to different degrees after injection-moulding, the part shrinking to a greater degree at least partially surrounding the part of the feeding bottle shrinking to a lesser degree, so that it clamps the part located on the inside. Moreover, the drinking teat and bottle may be connected by a material connection to one another, by the plastic of the drinking teat and the plastic of the bottle being selected so that they fuse together and/or are cross-linked together in the contact regions. Moreover, a material connection is possible by bonding. In this manner, feeding bottles may be produced with a very rigid connection between the drinking teat and bottle. The drinking teat may have a wide lip bearing surface which is comfortable for the baby, as the clamping edge for a threaded ring is absent. By the reinforcement thread extending from the bottle through the drinking teat up to the drinking opening, an additional increase in the strength is also achieved in the region of the drinking teat. The reinforcement thread may be connected to the drinking teat positively and/or non-positively and/or by a material connection. A positive connection is, for example, possible by partially or completely embedding the reinforcement thread into the material of the drinking teat. A completely embedded reinforcement thread is surrounded on all sides by the material of the teat nipple. A non-positive connection may be achieved by pressing the reinforcement thread into a groove of the drinking teat. Preferred is the material connection which may be achieved by cross-linking and/or fusing the contact regions of the reinforcement thread and drinking teat. A further possibility for the material connection is the bonding of the reinforcement thread and drinking teat. The reinforcement thread may prevent the drinking teat from being torn from the bottle and/or the teat nipple from being torn from the drinking teat. Destruction of the drinking bottle and/or swallowing of plastic parts is thus avoided.

The reinforcement thread may extend along only one side of the drinking teat. According to one embodiment, the reinforcement thread is deflected in a U-shaped manner in the outer end region of the teat nipple and extends over both sides of the drinking teat. Preferably, both ends of the reinforcement thread are arranged in the region of the bottle.

In one embodiment, the reinforcement thread follows a contour of the teat nipple. The reinforcement thread may thus be connected to the teat nipple over its entire path. It is particularly easily inserted into the teat nipple, only impairs the flexibility of the teat nipple slightly and leads to a secure connection between the teat nipple and the bottle.

In one embodiment, the reinforcement thread extends on the inside of the teat nipple. The reinforcement thread may be spaced apart from the outside of the teat nipple and may be surrounded by a material layer of the teat nipple. As a result, a user does not come into contact with the material of the teat nipple, which permits additional freedom in the selection of material.

Different flexible materials are considered for the drinking teat. For example, a natural rubber or a synthetic rubber or a different elastomer may be used. A drinking teat already comprising the reinforcement thread and made of a natural rubber or a synthetic rubber with a suitable profiling of the connecting region to the bottle may be inserted into an injection mould for a bottle and by injection-moulding the material of the bottle may be positively connected to the bottle. Thus the reinforcement thread may protrude in the opening edge of the drinking teat, so that it may be connected to the plastic of the bottle. Moreover, synthetic rubbers capable of being injection-moulded, for example liquid silicone rubber (LSR), are available which may be connected in a multi-component injection-moulding method to the material of the bottle.

According to a further embodiment, the flexible plastic is a thermoplastic elastomer (TPE). Thermoplastic elastomers may advantageously be processed by injection-moulding. Thermoplastic elastomers may be multiphase plastics, which comprise rubber elastic deformable molecular domains into which areas of amorphous thermoplastic are incorporated. They are, therefore, thermoplastically deformable and have at the same time the desired elastic properties. The feeding bottle with a drinking teat made of thermoplastic elastomer may, in particular, be produced in a multi-component injection-moulding method.

Preferably, the bottle consists of a hard-elastic plastic or hard plastic. The hard-elastic plastic or hard plastic lends sufficient strength to the bottle. In this case, in particular, it may be a thermoplastic (for example polypropylene (PP)) or a thermosetting plastic.

The reinforcement thread may be of various designs. In this case, for example, it may be a textile thread consisting of a plurality of threads connected to one another and/or twisted. The reinforcement thread may, however, also be a band or strip. Preferably, the band or strip is a film. Preferably, the reinforcement thread is connected to the bottle. The connection of the reinforcement thread and bottle may be positive and/or non-positive and/or may be a material connection. For the positive connection, the reinforcement thread may be anchored, for example, with thickened ends in the material of the bottle. For a non-positive connection, it may be pressed with the ends in receivers of the bottle. For a material connection, it may be connected at least one end by cross-linking or by bonding to the material of the bottle.

Preferably, the reinforcement thread consists of plastic. Further preferably, the reinforcement thread consists of the same plastic as the bottle (for example PP). The closure pin and reinforcement thread and bottle made of the same plastic may be injection-moulded in one piece in one or more steps. The reinforcement thread is then, in particular, connected by a material connection to the bottle.

In one embodiment, the drinking teat consists of a relatively soft silicone and the reinforcement thread consists of a relatively hard silicone.

In one embodiment, the drinking teat consists of silicone and the reinforcement thread consists of a heat-resistant plastic. Due to the tempering required for curing the silicone, a heat-resistant plastic is used. “Heat-resistant” means that the melting point of the plastic is above the temperature for the heat treatment of the silicone, for example above 100° C. or 150° C.

In one embodiment, the heat-resistant plastic for the reinforcement thread is a polyetheretherketone (PEEK). PEEK has a sufficiently high melting point in order to withstand the temperatures during heat treatment of the silicone, and has advantageous mechanical properties for use as a reinforcement thread.

In one embodiment, the drinking teat consists of a relatively soft, thermoplastic elastomer and the reinforcement thread consists of a relatively hard plastic. When using a thermoplastic elastomer for the drinking teat, the selection of a compatible plastic for the reinforcement thread is simpler than when using silicone. For example, a thermoplastic elastomer may also be used for the relatively hard plastic. The thermoplastic elastomer of the reinforcement thread may have the same base polymer as the thermoplastic elastomer of the teat part. The relatively hard plastic may also be PEEK in this embodiment.

In one embodiment, the relatively hard material has a filling material or a fibrous material. As a result, the strength of the reinforcement thread may be increased.

The feeding bottle may be closed in different ways, in order to prevent food from being inadvertently spilt. For example, the drinking teat may be designed without a drinking opening, so that the user has to produce a drinking opening by slitting-open, punching or the like. Moreover, a plug may be inserted into a prepared drinking opening.

According to a further embodiment, a closure pin protrudes from the drinking opening of the drinking teat.

According to a preferred embodiment, a closure pin protruding from the drinking opening is injection-moulded onto the drinking teat. The closure pin is integrally connected by injection-moulding to the drinking teat. The drinking opening may be opened by twisting off or cutting off the closure pin.

Preferably, the closure pin is designed to be sleeve-shaped with an outer, closed end, so that by at least partially twisting off or cutting off the closure pin the through-passage of the sleeve is opened and, as a result, liquid may be removed from the bottle. When the closure pin is designed as a hollow cylinder, the through-passage opened by cutting off the closure pin always has approximately the same cross section, irrespective of the point at which the closure pin is cut off. As a result, when applying a specific negative suction pressure, approximately the same quantity of liquid is removed.

The through-passage of the sleeve may be conical, so that by cutting off the closure pin at different points various through-flow cross sections may be opened. According to one embodiment, the closure pin has a material weakness, so that it is possible to cut off the closure pin at least partially at the point of the material weakness. With a sleeve-shaped closure pin having a material weakness, when partially cutting off the closure pin along the material weakness a through-passage is opened, which always incorporates the same cross section. As a result, when applying a specific negative suction pressure, approximately the same quantity of liquid is removed. The material weakness may be positioned so that during sucking the child may not be injured by the remainder of the closure pin which protrudes. To this end, the material weakness may be positioned inside the drinking opening.

The closure pin may consist of the same material as the drinking teat. It may be injection-moulded onto the drinking opening or onto the base of the drinking opening. With a sleeve-shaped design of the closure pin, an annular gap may be present between the closure pin and the drinking opening.

According to a further embodiment, the closure pin protrudes from the drinking opening in the extension of the reinforcement thread. The closure pin may be connected positively and/or non-positively and/or by a material connection to the reinforcement thread. For a positive connection, the reinforcement thread and closure pin may comprise interlocking profiles. For a non-positive connection the reinforcement thread may be pressed into a receiver of the closure pin. For a material connection, the closure pin and reinforcement thread may consist of materials which are fused with one another and/or cross-linked with one another and/or bonding may be carried out between the closure pin and reinforcement thread. Preferably, the closure pin consists of the same material as the reinforcement thread so that the closure pin and the reinforcement thread may be injection-moulded as a cohesive part in one or more steps.

When the closure pin protrudes from the drinking opening in the extension of the reinforcement thread, it may be sealingly arranged on the periphery in the drinking opening. By cutting off the closure pin from the reinforcement thread, the drinking opening may be opened. The opening cross section of the drinking opening is thus not altered, so that when applying a specific negative suction pressure the same quantity of liquid is always dispensed. For facilitating the cutting of the closure pin from the reinforcement thread, the closure pin or its connection with the reinforcement thread or the reinforcement threads may have a material weakness.

Even when the closure pin protrudes from the drinking opening in the extension of the reinforcement thread, the closure pin may also be surrounded in the drinking opening by an annular gap. For sealing the drinking opening before cutting off the closure pin, the reinforcement thread may cover the drinking opening at the bottom.

To this end, the reinforcement thread underneath the drinking opening may be enlarged to form a plate which covers the drinking opening from below. For cutting off the closure pin from the reinforcement thread, the closure pin or the connection of the closure pin to the reinforcement thread and/or the plate or the reinforcement thread and/or the plate may comprise a material weakness. Moreover, the reinforcement thread and/or the plate may have a central hole on which a sleeve-shaped closure pin is located, which is closed outside the drinking opening. The sleeve-shaped closure pin may have a material weakness which permits an upper portion of the closure pin to be cut off, which upper portion is closed. After cutting off the upper portion of the closure pin, the through-passage of the sleeve-shaped closure pin is opened, which is connected through the hole in the reinforcement thread and/or in the plate to the inside of the feeding bottle. The through-passage of the sleeve-shaped closure pin opened by cutting off the upper portion of the closure pin always has the same diameter. As a result, at a specific negative suction pressure, the feeding bottle always dispenses the same quantity of liquid.

According to a further embodiment, the closure pin has a widening on the upper face which serves as a grip for twisting off the closure pin. According to a further embodiment, the widening is a knob or a mushroom head.

The food may be introduced in different ways into the feeding bottle. According to one embodiment, initially a feeding bottle without a base is produced and filled through a lower opening. After filling the feeding bottle, the opening is closed with a base. The base may be connected in different ways in a liquid-tight manner to the bottle. It may, for example, be a closure plate or closure membrane, which is welded to edges of the opening or sealed thereto. Moreover, the base may have a screw connection with the bottle, the base being able to have an internal thread and the bottle an external thread or vice versa. The feeding bottle with a screw-on base may also be refilled and/or repeatedly used for dispensing food.

According to one embodiment, the feeding bottle—preferably at the bottom on the drinking teat and/or at the top on the bottle—has a grip ring and/or a grip groove. The bottle may be retained on the grip ring and/or on the grip groove, so that it does not slide out of the hand of the user.

According to a further embodiment, the feeding bottle has a protective cap for protecting the drinking teat, which has a snap connection and/or a screw connection with the upper region of the bottle. According to a preferred embodiment, the protective cap is snapped-in under a grip ring and/or in a grip groove of the bottle. The protective cap preferably consists of plastic (for example PP).

Preferably, the feeding bottle is prefilled with milk or another liquid food or a beverage. It may advantageously be used in conditions in which the sterility of the food or of the beverage has to be ensured and/or the cost of preparing the food has to be kept low. This is the case, for example, in hospital baby units and/or when used by the end user, in particular when travelling and/or in other situations in which equipment for food preparation is not available.

### BRIEF DESCRIPTION OF THE SEVERAL VIEWS OF THE DRAWINGS

The invention is described in more detail hereinafter with reference to the accompanying drawings of exemplary embodiments, in which:

FIG. 1 shows a feeding bottle consisting of a drinking teat and bottle injection-moulded to one another in a multi-component injection-moulding method and a closure membrane on the base in a vertical section;

FIG. 2 shows the upper region of the teat nipple of the feeding bottle of FIG. 1 in the same vertical section;

FIG. 3 shows the bottle and reinforcement thread of the same feeding bottle in a plan view, the angled portion of the reinforcement thread relative to the vertical not being shown for the sake of simplicity; and

FIG. 4 shows a feeding bottle consisting of a drinking teat and bottle injection-moulded to one another in a multi-component injection-moulding method, and a screw-on base in a partial vertical section.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

In the following description of different exemplary embodiments, parts of the feeding bottles corresponding to one another are provided with the same reference numerals.

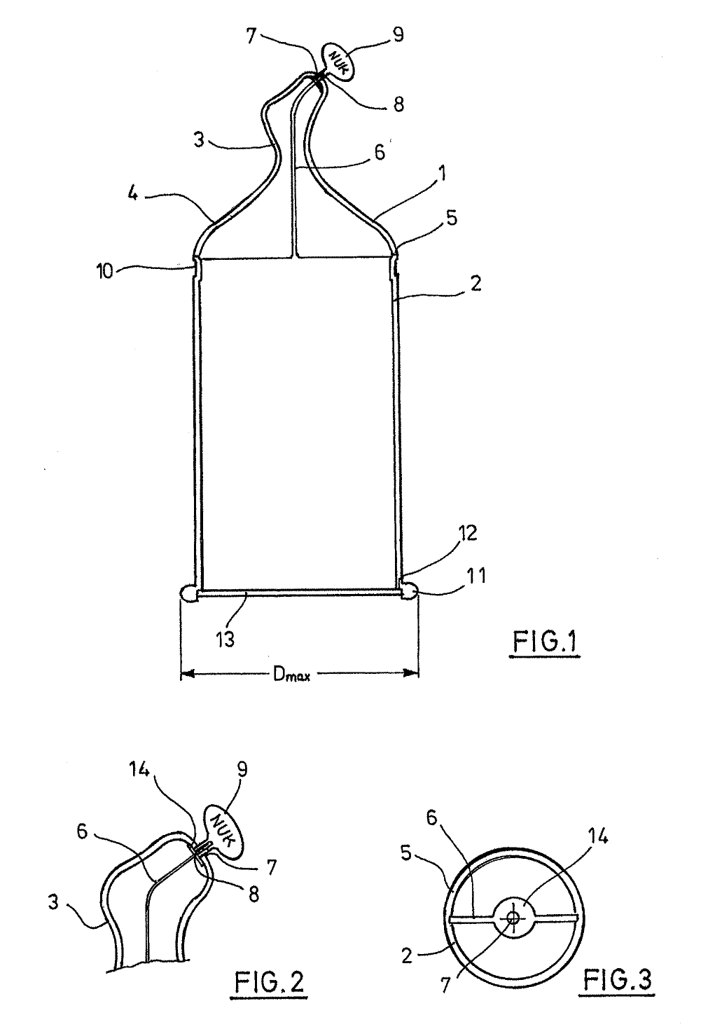

The feeding bottle of FIG. 1 comprises a drinking teat 1 and a bottle 2. The drinking teat 1 has an orthodontically-shaped teat nipple 3, and a transition region 4 widened in a dome-shaped manner. The transition region 4 is connected to the upper edge 5 of the substantially cylindrical or conical bottle 2. The transition region 4 provides a wide lip bearing surface which is comfortable for the baby, as a clamping edge and a threaded ring are absent.

On diametrically opposing sides a strip-shaped reinforcement thread 6 is connected to the edge 5 of the bottle 2. The reinforcement thread 6 is embedded in the wall of the drinking teat 1. It extends through the dome-shaped transition region 4 and the orthodontically-shaped teat nipple 3 as far as a drinking opening 7. The reinforcement thread 6 has an angled path in the upper region of the teat nipple 3.

The reinforcement thread 6 is integrally connected through the drinking opening 7 to a closure pin 8, which has at the top a mushroom-head-shaped or knob-like widening 9. The closure pin 8 is hollow in the region of a sleeve-shaped portion and closed at the top by the widening 9. Overall, it has the shape of a mushroom.

The bottle 2 has a peripheral grip groove 10 below the upper edge 5 on the outside.

At the bottom, the bottle 2 has an inner step 12 in a widened foot 11. A closure membrane 13 is sealed onto the inner step 12.

The maximum diameter of the feeding bottle Dmax is provided in the region of the foot 11. It is adapted to the requirements of hospital use and/or the equipment and appliances used there.

The bottle 2 has a scale, not shown, for displaying the filling level.

The drinking teat 1 is produced from a thermoplastic elastomer. It is preferably designed to be thin, so that it has good resilience. The thermoplastic elastomer may be selected so that it already ensures good resilience.

According to FIGS. 2 and 3, the reinforcement thread 6 which is connected at both ends to diametrically opposing regions of the upper edge 5 of the bottle 2, has a central circular plate 14. This surrounds the drinking opening 7. The plate 14 bears the closure pin 8. Thus the closure pin is fixed by the lower end of its sleeve-shaped portion to the plate 14, the through-passage of the sleeve-shaped portion being aligned with the central hole of the circular plate 14. The plate 14 seals the drinking opening 7 against the inside of the teat nipple 3. In particular, between the plate 14 and the closure pin 8 a set rupture point for twisting off the closure pin 8 may be present.

The sleeve-shaped portion of the closure pin 8 is passed through the drinking opening 7 of the drinking teat 1. Thus the sleeve-shaped portion may bear with its outer periphery against an inner periphery of the drinking opening 7 or be spaced apart therefrom by an annular gap. Preferably, the sleeve-shaped portion of the closure pin 8 is not connected to the inner periphery of the drinking opening 7. However, embodiments are also possible in which a more or less firm connection exists between the closure pin 8 and the inner periphery of the drinking opening 7.

The bottle 2 consists of polypropylene or another suitable thermoplastic. It is preferably transparent.

The bottle 2 is connected in one piece to the reinforcement thread 6 and the closure pin 8 as well as the widening 9.

The drinking teat 1 and the bottle 2 are produced in a two-component injection-moulding method. In a first injection-moulding step, the bottle 2 is injection-moulded in one piece with the reinforcement thread 6, the closure pin 8 and the widening 9. In a second step, the drinking teat 1 is injection-moulded, said drinking teat being fused or cross-linked at the contact points with the edge 5 to the bottle 2, the reinforcement thread 6 and the closure pin 8.

After injection-moulding, the feeding bottle is filled with milk or a different liquid food by standing on its head. Finally, the closure membrane 13 is sealed at the bottom.

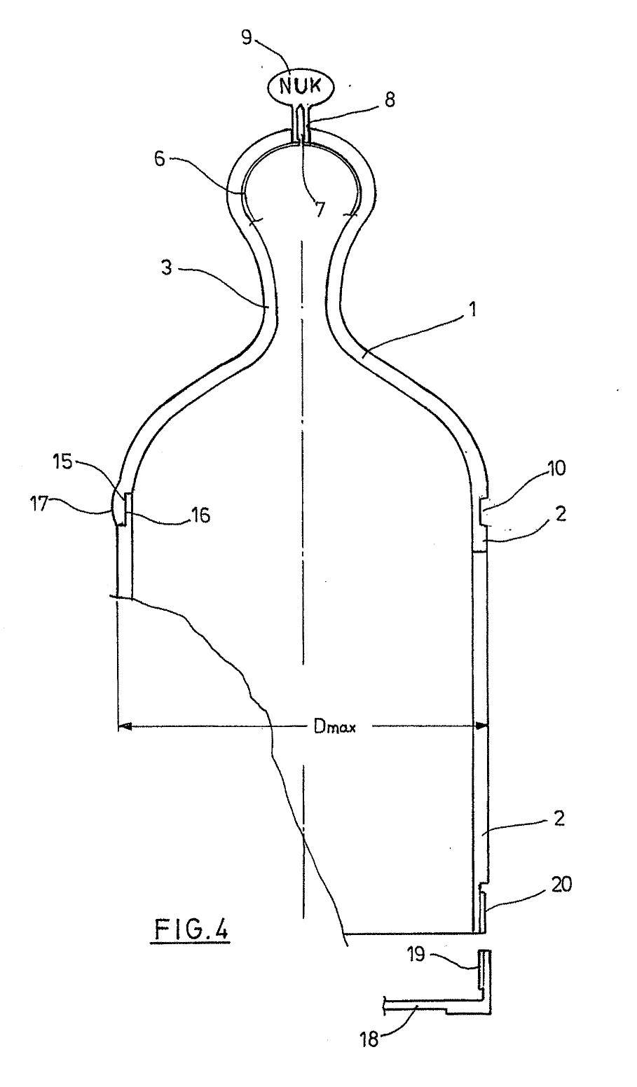

FIG. 4 shows a further feeding bottle with an orthodontic drinking teat 1 in a vertical section rotated relative to FIG. 1 by 90°.

In the right-hand half of FIG. 4, a connection between the drinking teat 1 and the bottle 2 is shown, which corresponds to the connection of the corresponding parts in the feeding bottle of FIG. 1. In the left-hand half of FIG. 4, a further embodiment of the connection is shown, in which the drinking teat 1 has an inner step 15 and the bottle 2 a complementary outer step 16, which in each case extend in a fully peripheral manner. In the region of these steps 15, 16, the drinking teat 1 and the bottle 2 are connected to one another positively and by a material connection by being injection-moulded together. Here, the drinking teat 1 has a grip ring 17 on the outside in the form of a bead, which may be used for holding the feeding bottle and for snapping-on a closure cap. In this case, it is advantageous that the grip ring 17 has a certain flexibility, so that it feels comfortable and/or a closure cap is held by resilient restoring forces.

Moreover, the feeding bottle of FIG. 4 differs from the feeding bottle according to FIGS. 1 to 3, in that the opening at the lower end of the bottle 2 is closed by a screwed-on base 18. To this end, the base 18 of cup-like configuration has an internal thread 19 on one periphery, and the bottle 2 is provided with an external thread 20 at the bottom. The base 18 is screwed by the internal thread 19 onto the external thread 20.

For use, the closure pin 8 is twisted off the feeding bottle according to FIG. 1 and/or FIG. 4, so that the drinking opening 7 is opened. The user may secure the bottle 2 on the grip groove 10 and/or the grip ring 17. For the flow of air, a ventilation opening and/or a sealing lip which opens in the event of negative pressure may be optionally present in the region of the base 13, 18. It is, however, also possible by retrospectively inserting a ventilation opening—for example a slot or a hole—to achieve ventilation of the feeding bottle. Optionally, ventilation may be achieved through the drinking opening 7, after putting down the feeding bottle.

This completes the description of the preferred and alternate embodiments of the invention. Those skilled in the art may recognize other equivalents to the specific embodiment described herein which equivalents are intended to be encompassed by the claims attached hereto.

1. Feeding bottle having
a drinking teat (1) made of a flexible plastic,
a bottle (2) made from plastic having a higher strength than the flexible plastic and connected to the drinking teat in one piece by means of injection-moulding, and
a reinforcement thread (6) extending from the bottle (2) through the drinking teat (1) up to the drinking opening (7).

2. The feeding bottle according to claim 1, in which the flexible material is a thermoplastic elastomer.

3. The feeding bottle according to claim 1, in which the bottle (2) consists of a hard-elastic plastic or hard plastic.

4. The feeding bottle according to claim 1, in which the reinforcement thread (6) consists of a flexible plastic.

5. The feeding bottle according to claim 3, in which the reinforcement thread (6) consists of the same plastic as the bottle (2).

6. The feeding bottle according to claim 1, with a closure pin (8) protruding from the drinking opening (7).

7. The feeding bottle according to claim 1, in which the closure pin (8) has a material weakness.

8. The feeding bottle according to claim 1, in which the closure pin (8) protrudes from the drinking opening (7) in the extension of the reinforcement thread (6).

9. The feeding bottle according to claim 1, in which the closure pin (8) consists of the same material as the reinforcement thread (6).

10. The feeding bottle according to claim 1, in which the closure pin (8) has a widening (9) on the upper face.

11. The feeding bottle according to claim 10, in which the widening (9) is a knob or a mushroom head.

12. The feeding bottle according to claim 1, in which the bottle (2) is closed at the bottom by a sealed-on closure membrane (13) or a screwed-on base (18).

13. The feeding bottle according to claim 1, in which the bottle (2) has a scale.

14. The feeding bottle according to claim 1, which has a grip ring (17) and/or a grip groove (10).

15. The feeding bottle according to claim 1, which has a protective cap which has a snap connection and/or a screw connection with the bottle (2) and/or the drinking teat (1).

16. The feeding bottle according to claim 15, in which the protective cap is snapped-in under a grip ring (17) and/or a grip groove (10) of the bottle (2).

17. The feeding bottle according to claim 1, which is filled with milk or another liquid food or beverage.
